(19) United States
(12) Patent Application Publication
(10) Pub. No.: US 2010/0135280 A1
(43) Pub. Date: Jun. 3, 2010

(54) TELECOMMUNICATIONS SYSTEM AND TELECOMMUNICATIONS MANAGEMENT APPARATUS

(75) Inventors: Kozo IKEGAMI, Yokohama (JP); Yasuo KOGURE, Yokohama (JP); Takashi YOKOYAMA, Yokohama (JP); Hiroaki MIYATA, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/616,657

(22) Filed: Nov. 11, 2009

(30) Foreign Application Priority Data
Nov. 28, 2008 (JP) 2008-303416

(51) Int. Cl. H04L 12/66; H04L 12/28

(52) U.S. Cl. 370/352; 370/411

(57) ABSTRACT

The migration of telephone services by a telecommunications carrier from a PSTN to an IP network entails that problem that when it is not possible for some telephone subscribers to migrate to the IP network due to the types of their telephone lines or services they subscribe to, other subscribers also cannot migrate to the IP network until the former subscribers migrate to the IP network.

The present invention provides a media gateway that enables a gradual transition from a PSTN to an IP network on a subscriber-by-subscriber basis or on a service-by-service basis so that a telecommunications carrier can efficiently migrate its subscribers while continuing to provide the services the subscribers currently use and reducing burdens on the subscribers.

### INCORPORATION BY REFERENCE

The present application claims priority from Japanese applications JP2008-303416 filed on Nov. 28, 2008, the content of which is hereby incorporated by reference into this application.

### BACKGROUND OF THE INVENTION

The present invention relates to media gateways that can be used as means for smoothly migrating telephone subscribers and telephone services from the traditional Public Switched Telephone Network (PSTN) to Internet Protocol (IP) networks. Due to the low profitability and aged components of the PSTN, the transition from the PSTN to IP networks is now being discussed. One advantage of IP networks over the PSTN is that the routers and switches that constitute IP networks are less expensive and lower in maintenance costs than the switches that constitute the PSTN. In addition, IP networks can provide unique services that are not possible with the PSTN.

To migrate telephone subscribers to an IP network, it is necessary to provide telephone services over the IP network. To achieve this, it is necessary to connect a terminal controller for Internet access to a telephone, convert voice data into IP packets with the terminal controller, and use the Session Initiation Protocol (SIP) for call control. There are two common methods for providing telephone services over an IP network. The first method involves the use of the Asymmetric Digital Subscriber Line (ADSL) technology. The ADSL technology uses copper telephone lines, and an ADSL modem on the subscriber side multiplexes telephone voice data and IP packets. By the ADSL modem having the function of converting voice data into IP packets, telephone services become possible over an IP network. The second method is to replace copper lines between a telecommunications carrier and its subscribers with optical fiber lines used for IP networks. Similar to the first method, by providing a subscriber with a device that converts voice data into IP packets, telephone services and Internet access services become possible over an IP network.

The first and second methods mentioned above, however, are only effective when a telephone subscriber already uses Internet access services. If those methods are applied to a telephone subscriber without Internet access services, there is a need to install a terminal controller at the subscriber's home or to replace a copper telephone line between the subscriber and the telecommunication carrier with an optical fiber line, which is considerably time-consuming and costly. Such being the case, there is another method for providing telephone services over an IP network. The method involves the use of a relay apparatus, called a media gateway, which is provided between the PSTN and an IP network (disclosed in Japanese Patent Publication No. 2005-094480).

While IP networks have advantages over the PSTN, they also have the disadvantage that they cannot provide services that are available over the PSTN. Thus, the ADSL technology mentioned above often employs such means as disclosed in WO No. 03/103259 so that the conventional PSTN is used when a service is not possible over an IP network.

### SUMMARY OF THE INVENTION

Upon migration of telephone services from the PSTN to an IP network, replacing a switch to which multiple subscriber lines are connected with a media gateway results in all the subscribers being transferred to the IP network. However, when it is not possible for some telephone subscribers to migrate to the IP network due to the types of their telephone lines or services they subscribe to, other subscribers also cannot migrate to the IP network until the former subscribers migrate to the IP network. Moreover, when a subscriber uses, for example, Service “A” that is available over both of the PSTN and an IP network and Service “B” that is only available over the PSTN, that subscriber cannot be transferred to a media gateway until the subscriber cancels Service “B” or until Service “B” becomes available over an IP network.

Thus, the migration of telephone services from the PSTN to an IP network with the use of media gateways requires a telecommunications carrier to efficiently migrate its subscribers while continuing to provide the services the subscribers currently use and reducing burdens on the subscribers.

A media gateway according to the invention is a telecommunications management apparatus with an IP network connection interface and a PSTN connection interface and provides network access for the terminals of telephone subscribers. Upon receipt of a call signal from one of the terminals, the media gateway connects the one of the terminals to the network predetermined by a maintenance person. Thus, the maintenance person can select networks to which to connect subscriber terminals on a subscriber-by-subscriber basis.

Further, when a subscriber specifies a particular service by a particular dial number, the media gateway connects his or her terminal to the network predetermined by the maintenance person. Thus, the maintenance person can select networks to which to connect subscriber terminals on a service-by-service basis.

During connection to the PSTN, the media gateway performs PSTN call control. During connection to an IP network, the media gateway performs IP network call control. In this manner, the media gateway can perform path connection processing.

When the media gateway receives a connection request addressed to a subscriber terminal for which the media gateway provides network access, the media gateway checks to see the connection status of the line of that terminal. If the line is available, the media gateway connects the subscriber terminal to the network through which the connection request was transmitted. Thus, the media gateway can perform path connection processing when it receives a connection request either from an IP network or the PSTN. When the media gateway receives a connection request addressed to a subscriber from the PSTN while the subscriber is connected to the IP network, the media gateway transmits a “busy” response to the PSTN, thereby notifying the caller that the line is busy. Likewise, when the media gateway receives an “INVITE” request addressed to a subscriber from an IP network while the subscriber is connected to the PSTN, the media gateway transmits a “Busy” response to the IP network, thereby notifying the caller that the line is busy. Further, when a call waiting service is available for a subscriber, the media gateway can transmit an incoming call alert to the subscriber. Thus, the media gateway can notify the subscriber of the receipt of a connection request from a caller during a call between the subscriber and another caller. Furthermore, the media gateway can provide a call waiting service across different types of networks (an IP network and the PSTN) by detecting a momentary on-hook signal from a subscriber to which a caller transmitted a connection request while the subscriber was connected to another caller, switching the subscriber's connection, and transmitting a busy response to the latter caller.

The media gateway comprises the following components: multiple subscriber interfaces; a switch; a TDM-IP converter; IP network interfaces; a PSTN interface; a subscriber interface controller; PSTN interface controller; a memory; and a processor that performs connection processing between subscribers and the PSTN via the subscriber interface controller and the PSTN interface controller, performs IP network connection processing, and sets up the switch. The memory stores data tables, examples of which include a table of subscriber information and associated network connection information, a table of dial numbers and associated network connection information, and a table indicating the line status information of subscribers.

In one aspect, a telecommunications management apparatus according to the invention comprises a first interface for exchanging information with a plurality of terminals; a storage device for storing identification information of the plurality of terminals and storing network connection information associated with the identification information; and a processor for receiving information from one of the plurality of terminals, reading from the storage device the network connection information associated with the identification information of the one of the plurality of terminals based on the received information, and connecting the one of the plurality of terminals based on the read network connection information to either a public switched telephone network or an IP network via the telecommunications management apparatus. A telecommunications system according to the invention includes the telecommunications management apparatus described above.

A telecommunications carrier can migrate telephone services from the PSTN to an IP network while reducing burdens on its telephone subscribers by replacing switches that provide network access for the subscribers with media gateways according to the invention. By a gradual transition from the PSTN to an IP network on a subscriber-by-subscriber basis, toll switches can be geographically consolidated in a planned manner in proportion to the number of subscribers using the PSTN. Further, by a graduation transition from the PSTN to an IP network on a service-by-service basis, all the existing services need not be provided over the IP network, and service migration can be done according to the order of priority. Furthermore, by setting a transition period in which services can be offered over both of an IP network and the PSTN, a service can be switched from the IP network to the PSTN if a problem arises, such as the suspension of that service over the IP network.

### BRIEF DESCRIPTION OF THE DRAWINGS

FIG. 1 shows an example of networks to which the invention is applied.

FIG. 2 illustrates the configuration of a media gateway according to the invention.

FIG. 3 is an example of a subscriber information table.

FIG. 4 is an example of a service table.

FIG. 5 is a flowchart illustrating the operation flow of a media gateway when the media gateway receives a call signal from a telephone subscriber.

FIG. 6 illustrates the operation sequence when the subscriber terminal 2 of FIG. 1 makes a call to the subscriber terminal 7 of FIG. 1.

FIG. 7 illustrates the operation sequence when the subscriber terminal 1 of FIG. 1 makes a call to the subscriber terminal 4 of FIG. 1 with the use of Service

FIG. 8 illustrates the operation sequence when the subscriber terminal 1 of FIG. 1 makes a call to the subscriber terminal 8 of FIG. 1 with the use of Service

FIG. 9 is an example of a line status table.

FIG. 10 is a flowchart illustrating the operation flow of a media gateway when the media gateway receives a connection request or an “INVITE” request addressed to a subscriber for which the media gateway provides network access.

FIG. 11 illustrates the operation sequence when the subscriber terminal 7 of FIG. 1 makes a call to the subscriber terminal 1 of FIG. 1.

FIG. 12 illustrates the operation sequence when the subscriber terminal 7 of FIG. 1 makes a call to the subscriber terminal 2 of FIG. 1, for which a call waiting service is not available, during a call between the subscriber terminals 2 and 4 of FIG. 1.

FIG. 13 illustrates the operation sequence when the subscriber terminal 7 of FIG. 1 makes a call to the subscriber terminal 3 of FIG. 1, for which a call waiting service is available, during a call between the subscriber terminals 3 and 4 of FIG. 1.

### DETAILED DESCRIPTION OF THE EMBODIMENTS

A preferred embodiment of the invention will now be described with reference to the accompanying drawings. The following explanation is based on the assumption that media gateways accommodate analog subscriber lines, but the invention can also be implemented with the use of ISDN lines. The following explanation is also based on the assumption that SIP, the Session Initiation Protocol, is used for call control over an IP network, but other similar protocols can also be used for that purpose.

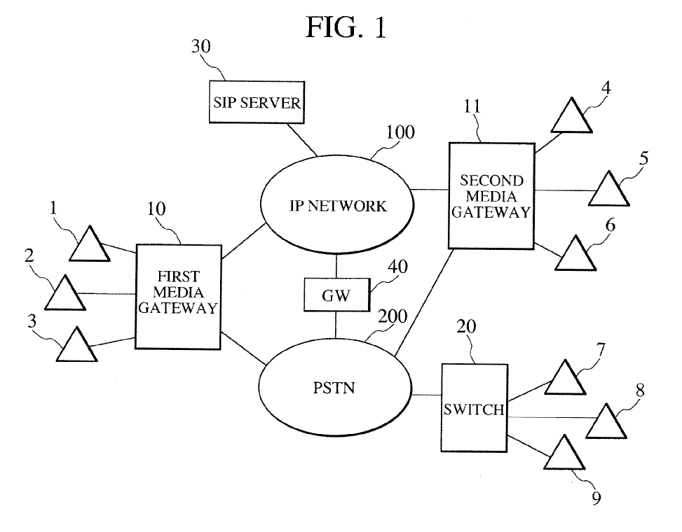

FIG. 1 illustrates an example of networks to which the invention is applied. A first media gateway 10 (also called a telecommunications management device) provides network access for subscriber terminals 1, 2, and 3 and a second media gateway 11 for subscriber terminals 4, 5, and 6. A conventional subscriber switch 20 provides network access for subscriber terminals 7, 8, and 9. The first and second media gateways 10 and 11 are both connected to an IP network 100 and the PSTN 200, and the switch 20 is connected to the PSTN 200. An SIP server 30 is connected to the IP network 100 so that the SIP server 30 connects a caller to a call recipient when the SIP is in use. A gateway 40 is provided between the IP network 100 and the PSTN 200 so that a subscriber connected to the IP network 100 can communicate with a subscriber connected to the PSTN 200.

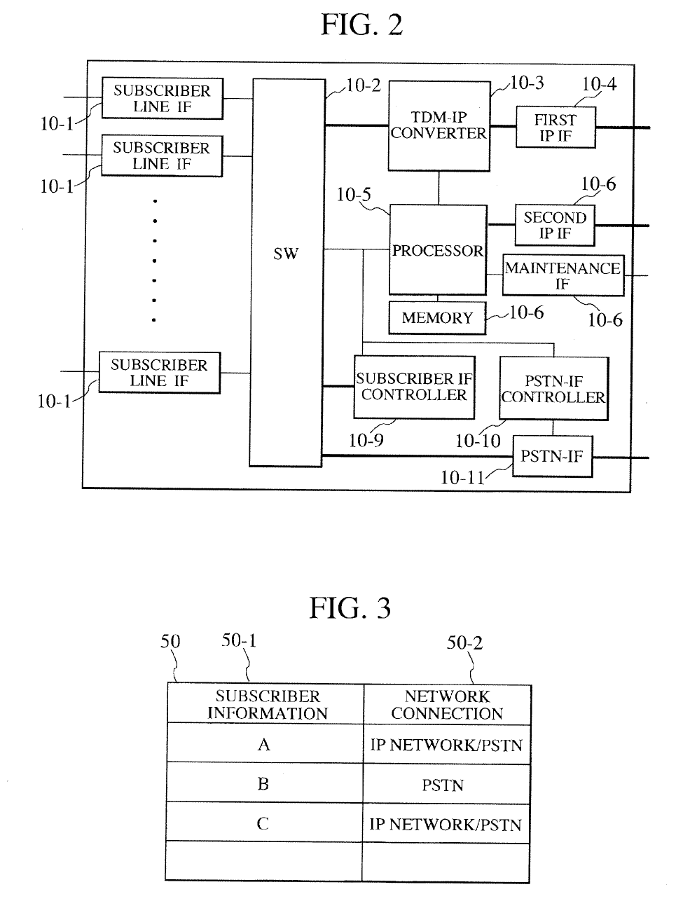

FIG. 2 is a configuration example of the first and second media gateways 10 and 11 (only one of them is shown). Multiple subscriber line interfaces 10-1 are connected to the subscriber side of a switch 10-2, and the switch 10-2 selectively connects the subscriber line interfaces 10-1 to a TDM-IP converter 10-3 or to a PSTN interface 10-11 in accordance with instructions from a processor 10-5. The network side of the switch 10-2 transmits a signal from the TDM-IP converter 10-3 or from the PSTN interface 10-11 to a particular one of the subscriber line interfaces 10-1 in accordance with an instruction from the processor 10-5. A second IP interface 10-6 is used for the processor 10-5 to exchange call control information with the SIP server 30. A first IP interface 10-4 is used for the transmission/receipt of subscriber data after the completion of connection processing. A memory (storage device) 10-8 is connected to the processor 10-5 to store various data tables, which are referred to by the processor 10-5. A maintenance interface 10-7 is also connected to the processor 10-5 for a maintenance person to overwrite or refer to the data tables. A subscriber interface controller 10-9 monitors signals from subscriber terminals and notifies the processor 10-5 upon receipt of a signal. The subscriber interface controller 10-9 also transmits signals to the subscriber terminals in accordance with instructions from the processor 10-5. A PSTN interface controller 10-10 monitors signals from the PSTN 200 and notifies the processor 10-5 upon receipt of a signal. The PSTN interface controller 10-10 also transmits signals to the PSTN 200 in accordance with instructions from the processor 10-5.

FIG. 3 is a subscriber information table 50 that is stored on the memories 10-8 of the first and second media gateways 10 and 11. The subscriber information table 50 includes subscriber information 50-1 and network connection information 50-2. The subscriber information 50-1 is used to identify respective subscribers. Examples of the subscriber information 50-1 include phone numbers, subscriber interfaces the first media gateway 10 or the second media gateway 11 accommodates, time slots, and services the subscribers use. The network connection information 50-2 indicates which network to connect each subscriber to, the IP network 100 or the PSTN 200. The network connection information 50-2 is set by the telecommunications carrier via the maintenance interface 10-7.

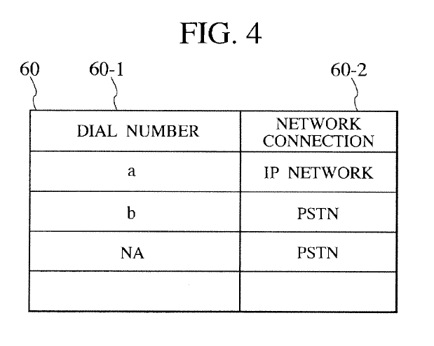

FIG. 4 is a service table 60 that is stored on the memories 10-8 of the first and second media gateways 10 and 11. The service table 60 includes dial number information 60-1 and network connection information 60-2. The dial number information 60-1 is the dial numbers subscribers use to specify particular services. The network connection information 60-2 indicates which network to connect each service to, the IP network 100 or the PSTN 200. The network connection information 60-2 is set by the telecommunications carrier via the maintenance interface 10-7. When a dial number is not applicable to the service table 60, the subscriber is connected to the network specified by “NA” in the column of the dial number information 60-1.

FIG. 9 shows a line status table 70 that is stored on the memories 10-8 of the first and second media gateways 10 and 11. The line status table 70 includes subscriber information 70-1 and line status information 70-2. The subscriber information 70-1 is used to identify respective subscribers as in the subscriber information table 50. The line status information 70-2 is updated when the processor 10-5 sets a connection destination for the switch 10-2 and changed to “Available” after the connection is lost.

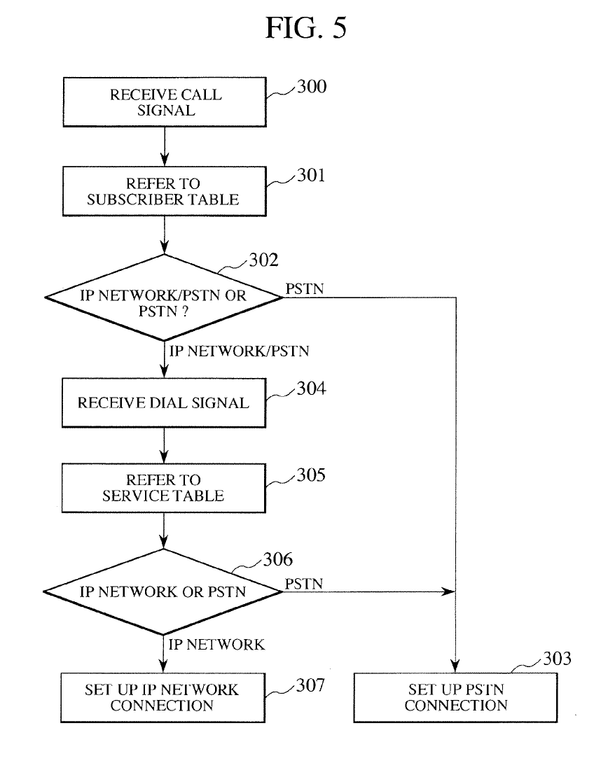

FIG. 5 is a flowchart illustrating the operation flow of the first media gateway 10 when it receives a call signal from one of the subscriber terminals 1 to 3. Note that the following explanation also applies to the second media gateway 11 when it receives a call signal from one of the subscriber terminals 4 to 6. When the first media gateway 10 receives a call signal from one of the subscriber terminals 1 to 3 (Step 300), it refers to the subscriber information table 50 (Step 301) to see which network is set (“IP network/PSTN” or “PSTN”) for the network connection information 50-2 associated with the subscriber information 50-1 of that subscriber terminal which transmitted the call signal (Step 302). When the network connection information 50-2 indicates “PSTN,” the first media gateway 10 sets up a PSTN connection (Step 303). When the network connection information 50-2 indicates “IP network/PSTN,” the first media gateway 10 waits for the subscriber terminal to transmit a dial signal. After the receipt of a dial signal (Step 304), the first media gateway 10 refers to the service table 60 (Step 305) to see which network is set (“IP network” or “PSTN”) for the network connection information 60-2 associated with the dial number used (Step 306). When the network connection information 60-2 indicates “PSTN,” the first media gateway 10 sets up a PSTN connection (Step 303). When the network connection information 60-2 indicates “IP network,” the first media gateway 10 sets up an IP network connection (Step 307).

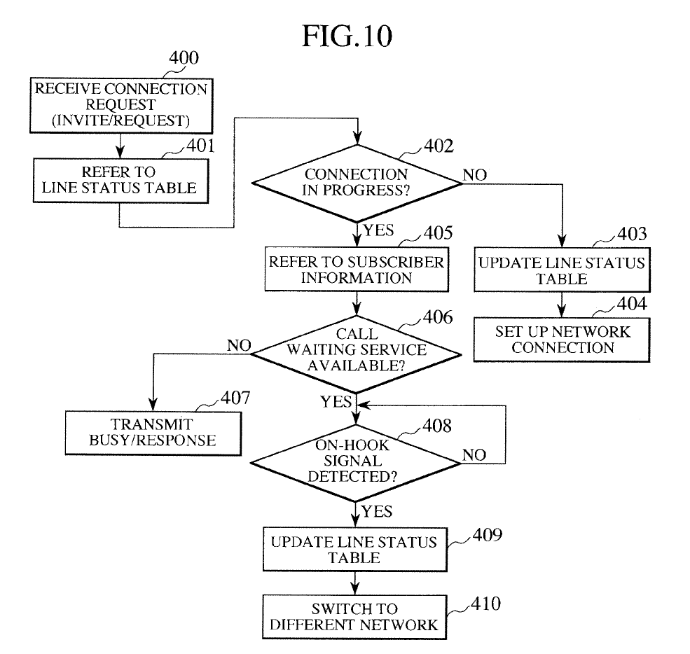

FIG. 10 illustrates the operation flow of the first media gateway 10 when there is a connection request addressed to one of the subscriber terminals 1 to 3. Note that the following explanation also applies to the second media gateway 11 when there is a connection request addressed to one of the subscriber terminals 4 to 6. After the first media gateway 10 receives from the PSTN 200 a connection request addressed to one of the subscriber terminals 1 to 3 (Step 400), the first media gateway 10 refers to the line status table 70 (Step 401). The first media gateway 10 checks to see whether the subscriber terminal to which the connection request is addressed is available or not by referring to the line status information 70-2 associated with the subscriber information 70-1 of that subscriber terminal (Step 402). If the line status information 70-2 indicates the subscriber terminal is “Available,” the first media gateway 10 changes the line status information 70-2 of the subscriber terminal from

“Available” to “Connected to PSTN” (Step 403) and then sets up a PSTN connection (Step 404). If, on the other hand, the line status information 70-2 indicates that the subscriber terminal is being “Connected to IP Network,” the first media gateway 10 refers to the subscriber information 70-1 (Step 405) to see whether a call waiting service is available for the subscriber terminal or not (Step 406). If the service is not available, the first media gateway 10 transmits a “busy” response to the PSTN 200 (Step 407). If the service is available, the first media gateway 10 monitors the subscriber terminal for a momentary on-hook signal (Step 408). After detecting a momentary on-hook signal, the first media gateway 10 changes the line status information 70-2 of the subscriber terminal from “Connected to IP Network” to “Connected to IP Network/PSTN” (Step 409) and changes the network connection of the subscriber terminal from the IP network 100 to the PSTN 200 (Step 410). Likewise, after the first media gateway 10 receives from the IP network 100 an “INVITE” request addressed to one of the subscriber terminals 1 to 3 (Step 400), the first media gateway 10 refers to the line status table 70 (Step 401). The first media gateway 10 checks to see whether the subscriber terminal to which the “INVITE” request is addressed is available or not by referring to the line status information 70-2 of that subscriber terminal (Step 402). If the line status information 70-2 indicates the subscriber terminal is “Available,” the first media gateway 10 changes the line status information 70-2 of the subscriber terminal from “Available” to “Connected to IP Network” (Step 403) and then sets up an IP network connection (Step 404). If, on the other hand, the line status information 70-2 indicates that the subscriber terminal is being “Connected to PSTN,” the first media gateway 10 refers to the subscriber information 70-1 (Step 405) to see whether a call waiting service is available for the subscriber terminal or not (Step 406). If the service is not available, the first media gateway 10 transmits a “busy” response to the IP network 100 (Step 407). If the service is available, the first media gateway 10 monitors the subscriber terminal for a momentary on-hook signal (Step 408). After detecting a momentary on-hook signal, the first media gateway 10 changes the line status information 70-2 of the subscriber terminal from “Connected to PSTN” to “Connected to IP Network/PSTN” (Step 409) and changes the network connection of the subscriber terminal from the PSTN 200 to the IP network 100 (Step 410).

The following explains more in detail the operation of the first media gateway 10 when it receives a call signal from one of the subscriber terminal 1 to 3. The operation of the first media gateway 10 when there is a connection request addressed to one of the subscriber terminals 1 to 3 will later be described in detail.

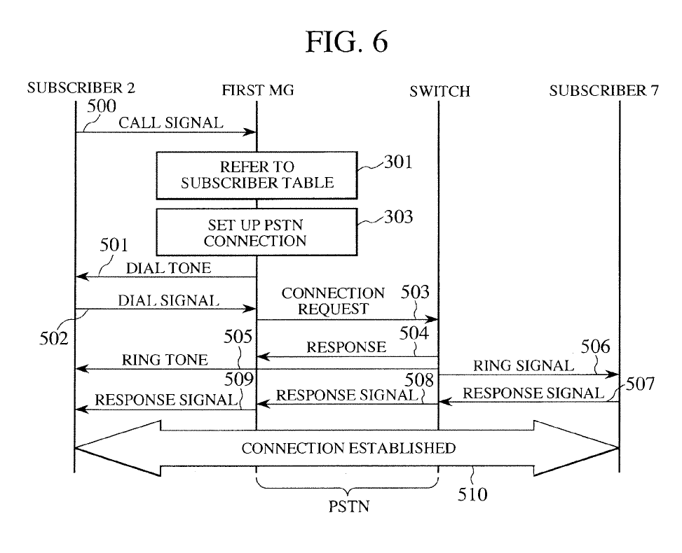

With reference now to FIG. 6, how to establish a connection between the subscriber terminal 2, the caller, and the subscriber terminal 7, the call recipient, through the first media gateway 10 and the switch 20 will be discussed. Note that the subscriber information 50-1 of the subscriber terminal 2 is “B” of FIG. 3. After the subscriber terminal 2 transmits a call signal (Step 500), the switch 10-2 of the first media gateway 10 receives the signal via the subscriber line interface 10-1 of the subscriber terminal 2 (Step 300). The switch 10-2 then transmits the signal to the subscriber interface controller 10-9, and the subscriber interface controller 10-9 in turn notifies the processor 10-5 of its receipt of the signal with the “B” subscriber information 50-1. The processor 10-5 that has received the notification refers to the subscriber information table 50 (Step 301) to read the network connection information 50-2 associated with the “B” subscriber information 50-1. In this case, the processor 10-5 recognizes the network connection information 50-2 as being the PSTN 200, as shown in FIG. 3 (Step 302). The processor 10-5 then instructs the switch 10-2 to connect the subscriber line with the “B” subscriber information 50-1 to the PSTN interface 10-11 (Step 303). In the meantime, the subscriber interface controller 10-9 transmits a dial tone to the subscriber terminal 2 via the switch 10-2 at the same time as the receipt of the call signal (Step 501). After the subscriber terminal 2 transmits a dial signal to the switch 10-2 by dialing the number of the subscriber terminal 7 (Step 502), the switch 10-2 transmits the dial signal to the processor 10-5, and the processor 10-5 transmits a connection request to a given toll switch on the PSTN 200 through the PSTN interface controller 10-10 and the PSTN interface 10-11 (Step 503). The connection request is transmitted from the toll switch on the PSTN 200 to the switch 20 (Step 503). The switch 20 that provides network access for the subscriber terminal 7 then transmits a response to the first media gateway 10 in response to the connection request (Step 504) and also transmits a ring signal to the subscriber terminal 7 (Step 506). After the completion of the connection processing, the switch 20 transmits a ring tone to the subscriber terminal 2 (Step 505). After the subscriber terminal 7 transmits a response signal to the switch 20 in response to the ring signal (Step 507), the switch 20 transmits a response signal to the first media gateway 10 (Step 508). Thereafter, the PSTN interface controller 10-10 of the first media gateway 10 notifies the processor 10-5 of the receipt of the response signal, and the processor 10-5 transmits a response signal to the subscriber terminal 2 through the subscriber interface controller 10-9 (Step 509). This establishes a connection between the subscriber terminal 2 and the subscriber terminal 7 (Step 510).

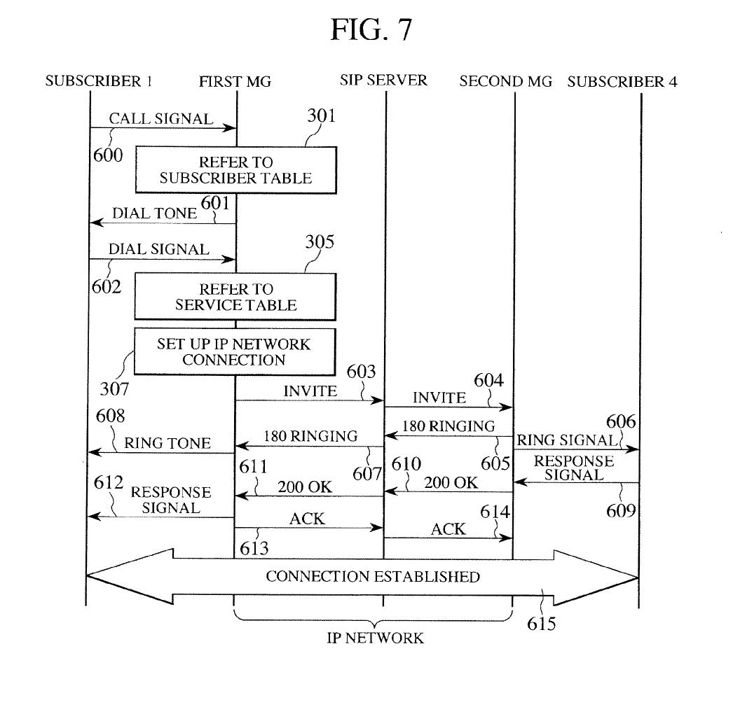

With reference now to FIG. 7, how to establish a connection between the subscriber terminal 1, the caller, and the subscriber terminal 4, the call recipient, through the first media gateway 10 and the second media gateway 11 will be discussed. Note that the subscriber information 50-1 of the subscriber terminal 1 is “A” of FIG. 3 and that the subscriber terminal 1 uses the service specified by the dial number “a” of FIG. 4. Similar to FIG. 6, after the subscriber terminal 1 transmits a call signal (Step 600), the first media gateway 10 receives the signal (Step 300). The processor 10-5 of the first media gateway 10 then refers to the subscriber information table 50 (Step 301) to read the network connection information 50-2 associated with the “A” subscriber information 50-1. In this case, the processor 10-5 of the first media gateway 10 recognizes the network connection information 50-2 as being the IP network 100 or the PSTN 200, as shown in FIG. 3 (Step 302). At the same time as the receipt of the call signal, the subscriber interface controller 10-9 of the first media gateway 10 transmits a dial tone to the subscriber terminal 1 (Step 601). After the subscriber terminal 1 transmits a dial signal by dialing the number of the subscriber terminal 4 (Step 602), the processor 10-5 of the first media gateway 10 receives the dial signal (Step 304) and refers to the service table 60 (Step 305) to read the network connection information 60-2 associated with the dial number “a.” In this case, the processor 10-5 of the first media gateway 10 recognizes the network connection information 60-2 as being the IP network 100, as shown in FIG. 4 (Step 306). The processor 10-5 of the first media gateway 10 then instructs the switch 10-2 of the first media gateway 10 to connect the subscriber line with the “A” subscriber information 50-1 to the TDM-IP converter 10-3 of the first media gateway 10 (Step 307). The processor 10-5 of the first media gateway 10 transmits an “INVITE” request to the SIP server 30 via the second IP interface 10-6 of the first media gateway 10 (Step 603). The SIP server 30 transfers the “INVITE” request to the second media gateway 11 that provides network access for the subscriber terminal 4 (Step 604). After the receipt of the “INVITE” request, the second media gateway 11 transmits a “180 Ringing” response to the SIP server 30 (Step 605) and also transmits a ring signal to the subscriber terminal 4 (Step 606). The SIP server 30 then transfers the “180 Ringing” response to the first media gateway 10 (Step 607). After the receipt of the “180 Ringing” response, the first media gateway 10 transmits a ring tone to the subscriber 1 (Step 608). After the subscriber terminal 4 transmits a response signal to the second media gateway 11 (Step 609), the second media gateway 11 transmits a “200 OK” response to the SIP server 30 (Step 610). The SIP server 30 transfers the “200 OK” response to the first media gateway 10 (Step 611). After the receipt of the “200 OK” response, the first media gateway 10 transmits a response signal to the subscriber terminal 1 (Step 612) and also transmits an “ACK” response to the SIP server 30 (Step 613). The SIP server 30 transfers the “ACK” response to the second media gateway 11 (Step 614). This establishes a connection between the subscriber terminal 1 and the subscriber terminal 4 (Step 615).

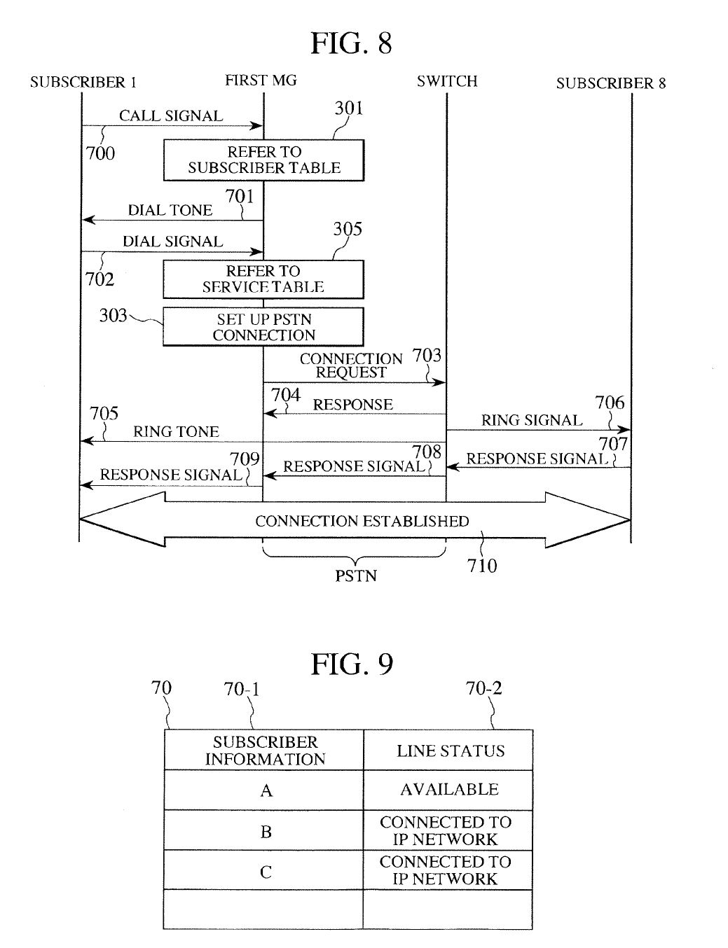

With reference now to FIG. 8, how to establish a connection between the subscriber terminal 1, the caller, and the subscriber terminal 8, the call recipient, through the first media gateway 10 and the switch 20 will be discussed. Note this time that the subscriber information 50-1 of the subscriber terminal 1 is “A” of FIG. 3 and that the subscriber terminal 1 uses the service specified by the dial number “b” of FIG. 4. The operation sequence from the subscriber terminal 1 transmitting a call signal (Step 700) up to the processor 10-5 of the first media gateway 10 referring to the service table 60 (Step 305) is the same as in the above case of FIG. 7. Thereafter, the processor 10-5 reads from the service table 60 the network connection information 60-2 associated the dial number “b” and recognizes the network connection information 60-2 as being the PSTN 200, as shown in FIG. 4 (Step 306). The processor 10-5 then sets up a PSTN connection (Step 303). Similar to the case of FIG. 6, the above process is then followed by the transmission of a connection request (Step 703) and finally by the transmission of a response signal to the subscriber 1 (Step 709), thereby establishing a connection between the subscriber terminal 1 and the subscriber terminal 8.

The operation of the first media gateway 10 when there is a connection request addressed to one of the subscriber terminals 1 to 3 will now be discussed in detail.

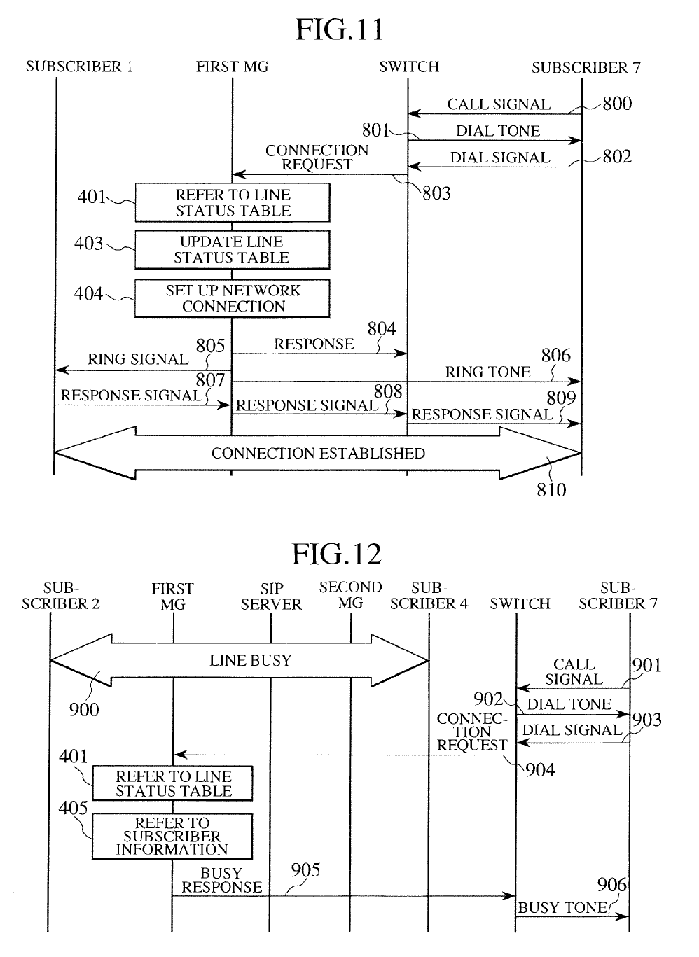

With reference now to FIG. 11, how to establish a connection between the subscriber terminal 7, the caller, and the subscriber terminal 1, the call recipient, through the switch 20 and the first media gateway 10 will be discussed. Note in this case that the subscriber information 70-1 of the subscriber terminal 1 is “A” of FIG. 9 and that the line of the subscriber terminal 1 is not busy. The process starts with the transmission of a call signal from the subscriber terminal 7 (Step 800). The switch 20 then transmits a dial tone to the subscriber terminal 7 (Step 801). After the subscriber terminal 7 dials the number of the subscriber terminal 1 (Step 802), the switch 20 transmits a connection request to the first media gateway 10 that provides network access for the subscriber terminal 1 (Step 803). After the first media gateway 10 receives the connection request (Step 400), the PSTN interface controller 10-10 notifies the processor 10-5 of the receipt of the connection request addressed to the subscriber terminal 1 with the “A” subscriber information 70-1. The processor 10-5 then refers to the line status table 70 (Step 401) to see the line status information 70-2 associated with the “A” subscriber information 70-1 of the subscriber terminal 1 (Step 402). In this case, the processor 10-5 recognizes the line status information 70-2 as being “Available,” as shown in FIG. 9. Thus, the processor 10-5 changes the line status information 70-2 from “Available” to “Connected to PSTN” (Step 403) and instructs the switch 10-2 to connect the subscriber line with the “A” subscriber information 70-1 to the PSTN interface 10-11 (Step 404). The processor 10-5 then transmits a response to the switch 20 via the PSTN interface controller 10-10 (Step 804) and also transmits a ring signal to the subscriber terminal 1 via the subscriber interface controller 10-9 (Step 805). After the completion of the connection processing, the processor 10-5 transmits a ring tone to the subscriber terminal 7 via the PSTN interface controller 10-10 (Step 806). After the subscriber terminal 1 transmits a response signal to the first media gateway 10 (Step 807), the subscriber interface controller 10-9 notifies the processor 10-5 of the receipt of the response signal from the subscriber terminal 1, and the processor 10-5 transmits a response signal to the switch 20 via the PSTN interface controller 10-10 (Step 808). After the receipt of the response signal from the processor 10-5, the switch 20 transmits a response signal to the subscriber terminal 7 (Step 809). This establishes a connection between the subscriber terminal 7 and the subscriber terminal 1 (Step 810).

With reference next to FIG. 12, the process flow when the subscriber terminal 7, for which the switch 20 provides network access, transmits a connection request addressed to the subscriber terminal 2, for which the first media gateway 10 provides network access, will be discussed. Assume this time that the subscriber information 70-1 of the subscriber terminal 2 is “B” of FIG. 9, that a call waiting service is not available for the subscriber terminal 2, and that the subscriber terminal 7 transmits a connection request addressed to the subscriber terminal 2 while the subscriber terminal 2 is connected via the IP network 100 to the subscriber terminal 4, for which the second media gateway 11 provides network access. While the subscriber terminals 2 and 4 are connected (Step 900), the subscriber terminal 7 transmits a call signal to the switch 20 (Step 901). The switch 20 transmits a dial tone to the subscriber terminal 7 (Step 902). After the subscriber terminal 7 dials the number of the subscriber terminal 2 (Step 903), the switch 20 transmits a connection request addressed to the subscriber terminal 2 to the first media gateway 10 (Step 904). Similar to the above case of FIG. 11, the processor 10-5 of the first media gateway 10 then refers to the line status table 70 (Step 401) to see the line status information 70-2 associated with the “B” subscriber information 70-1 of the subscriber terminal 2 (Step 402). In this case, the processor 10-5 of the first media gateway 10 recognizes the line status information 70-2 as being “Connected to IP Network” as shown in FIG. 9 and then refers to the subscriber information 70-1 (Step 405) to see whether a call waiting service is available for the subscriber terminal 2 (Step 406). Since the service is not available as stated above, the processor 10-5 of the first media gateway 10 transmits a “busy” response to the switch 20 via the PSTN interface controller 10-10 of the first media gateway 10 (Step 407 and Step 905). After the receipt of the response, the switch 20 transmits a busy tone to the subscriber terminal 7 (Step 906). This allows the caller using the subscriber terminal 7 to recognize the line of the subscriber terminal 2 is busy.

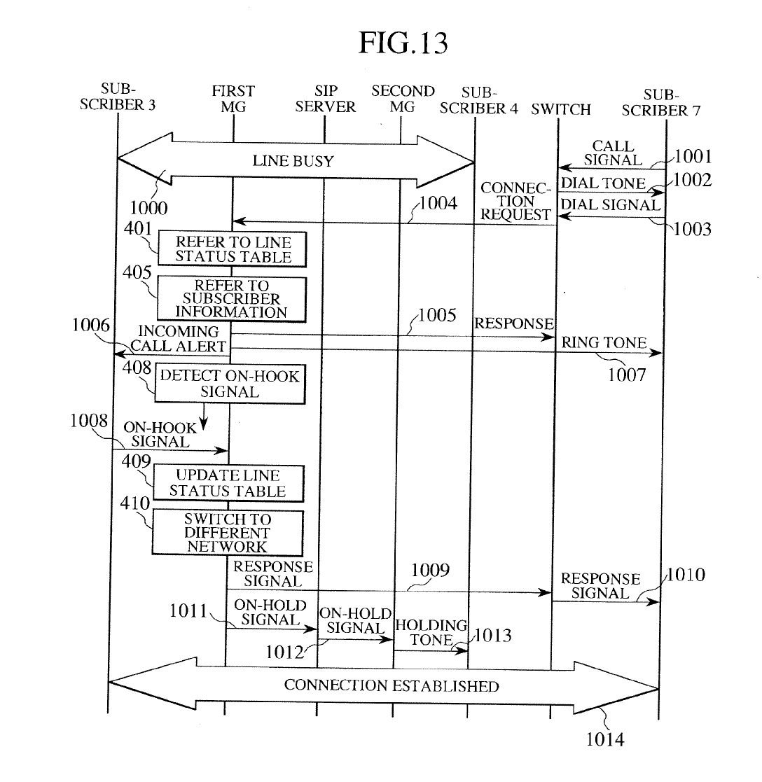

With reference next to FIG. 13, the process flow when the subscriber terminal 7, for which the switch 20 provides network access, transmits a connection request addressed to the subscriber terminal 3, for which the first media gateway 10 provides network access, will be discussed. Assume this time that the subscriber information 70-1 of the subscriber terminal 3 is “C” of FIG. 9, that a call waiting service is available for the subscriber terminal 3, and that the subscriber terminal 7 transmits a connection request addressed to the subscriber terminal 3 while the subscriber terminal 3 is connected via the IP network 100 to the subscriber terminal 4, for which the second media gateway 11 provides network access. While the subscriber terminals 3 and 4 are connected (Step 1000), the subscriber terminal 7 transmits a call signal to the switch 20 (Step 1001). The switch 20 transmits a dial tone to the subscriber terminal 7 (Step 1002). After the subscriber terminal 7 dials the number of the subscriber terminal 3 (Step 1003), the switch 20 transmits a connection request addressed to the subscriber terminal 3 to the first media gateway 10 (Step 1004). Similar to the above cases of FIGS. 11 and 12, the processor 10-5 of the first media gateway 10 then refers to the line status table 70 (Step 401) to see the line status information 70-2 associated with the “C” subscriber information 70-1 of the subscriber terminal 3 (Step 402). In this case, the processor 10-5 of the first media gateway 10 recognizes the line status information 70-2 as being “Connected to IP Network” as shown in FIG. 9 and then refers to the subscriber information 70-1 (Step 405) to see whether a call waiting service is available for the subscriber terminal 3 (Step 406). Since the service is available as stated above, the processor 10-5 of the first media gateway 10 transmits a response to the switch 20 via the PSTN interface controller 10-10 of the first media gateway 10 (Step 1005) and also transmits an incoming call alert signal to the subscriber terminal 3 via the subscriber interface controller 10-9 of the first media gateway 10 (Step 1006). After the completion of the connection processing, the processor 10-5 of the first media gateway 10 transmits a ring tone to the subscriber terminal 7 via the PSTN interface controller 10-10 of the first media gateway 10 (Step 1007), and the subscriber interface controller 10-9 of the first media gateway 10 monitors the subscriber terminal 3 for a momentary on-hook signal (Step 408). After the subscriber terminal 3 transmits a momentary on-hook signal (Step 1008), the subscriber interface controller 10-9 of the first media gateway 10 receives the signal and notifies the processor 10-5 of the first media gateway 10 of the receipt of the signal. Thereafter, the processor 10-5 of the first media gateway 10 changes the line status information 70-2 of the subscriber terminal 3 from “Connected to IP Network” to “Connected to IP Network/PSTN” (Step 409) and instructs the switch 10-2 of the first media gateway 10 to connect the line of the subscriber terminal 3 to the PSTN interface 10-11 of the first media gateway 10 (Step 410). Next, the processor 10-5 of the first media gateway 10 transmits a response signal to the switch 20 via the PSTN interface controller 10-10 of the first media gateway 10 (Step 1009) and also transmits an “on-hold” signal to the SIP server 30 via the second IP interface 10-6 of the first media gateway 10 (Step 1011). The SIP server 30 then transfers the on-hold signal to the second media gateway 11 (Step 1012). After receiving the on-hold signal via the second IP interface 10-6 of the second media gateway 11, the processor 10-5 of the second media gateway 11 transmits a holding tone to the subscriber terminal 4 via the subscriber interface controller 10-9 of the second media gateway 11 (Step 1013). After the receipt of the response signal from the first media gateway 10, the switch 20 transmits a response signal to the subscriber terminal 7 (Step 1010). This establishes a connection between the subscriber terminal 3 and the subscriber terminal 7 (Step 1014) while putting the subscriber terminal 4 on hold.

When a subscriber for which a media gateway provides network access transmits a connection request to a subscriber for which network access is provided by a switch connected to the PSTN, a service that involves the use of an IP network and a gateway that connects the IP network and the PSTN can be realized by the telecommunications carrier setting the network connection information of a subscriber information table to “IP Network/PSTN” and the network connection information of a service table to “IP Network.” On the other hand, when a subscriber for which a media gateway provides network access transmits a connection request to a subscriber connected only to an IP network, a service that involves the use of the PSTN and the above gateway can be realized by the telecommunications carrier setting the network connection information of the subscriber information table to “IP Network/PSTN” and the network connection information of the service table to “PSTN.”

When a media gateway receives through an IP network an “INVITE” request addressed to a subscriber for which the media gateway provides network access while the subscriber is connected to a caller through the PSTN, a “busy” response can instead be transmitted to an SIP server if a call waiting service is not available for the subscriber. Thus, the media gateway can notify the terminal that sent the “INVITE” request that the line of the subscriber is busy.

What is claimed is:

1. A telecommunications system comprising:
a plurality of terminals;
a telecommunications management apparatus connected to the plurality of terminals;
a public switched telephone network connected to the telecommunications management apparatus; and
an IP network connected to the telecommunications management apparatus;
wherein the telecommunications management apparatus includes:
a first interface for exchanging information with the plurality of terminals;
a storage device for storing identification information of the plurality of terminals and storing network connection information associated with the identification information; and
a processor for receiving information from one of the plurality of terminals, reading from the storage device the network connection information associated with the identification information of the one of the plurality of terminals based on the received information, and connecting the one of the plurality of terminals based on the read network connection information to either the public switched telephone network or the IP network via the telecommunications management apparatus.

2. The telecommunications system defined in claim 1, wherein the telecommunications management apparatus further includes:
a switch for controlling connection between the plurality of terminals and the telecommunications management apparatus based on a setting of the processor;
a second interface for exchanging information with the public switched telephone network; and
a third interface for exchanging information with the IP network.

3. The telecommunications system defined in claim 1, wherein the storage device further stores dial signal information of the plurality of terminals and network connection information associated with the dial signal information and wherein the processor receives dial signal information from one of the plurality of terminals, reads from the storage device the network connection information associated with the dial signal information received, and connects the one of the plurality of terminals based on the read network connection information to either the public switched telephone network or the IP network via the telecommunications management apparatus.

4. The telecommunications system defined in claim 1, wherein the storage device stores service subscriber identification information of the plurality of terminals as the identification information.

5. The telecommunications system defined in claim 3, wherein the storage device stores dial numbers used to specify particular services as the dial number information.

6. The telecommunications system defined in claim 1, wherein the storage device stores information on the IP network and the public switched telephone network as the network connection information.

7. The telecommunications system defined in claim 1, wherein the telecommunications management apparatus further includes a second interface for updating information stored on the storage device.

8. The telecommunications system defined in claim 1, wherein the storage device further stores identification information of the plurality of terminals and line status information associated with the identification information and wherein the processor receives information from one of the plurality of terminals, reads from the storage device the line status information associated with the identification information of the one of the plurality of terminals based on the received information, and connects the one of the plurality of terminals to either the public switched telephone network or the IP network via the telecommunications management apparatus when the read line status information indicates that the line of the one of the plurality of terminals is available.

9. A telecommunications management device comprising:
a first interface for exchanging information with a plurality of terminals;
a storage device for storing identification information of the plurality of terminals and storing network connection information associated with the identification information; and
a processor for receiving information from one of the plurality of terminals, reading from the storage device the network connection information associated with the identification information of the one of the plurality of terminals based on the received information, and connecting the one of the plurality of terminals based on the read network connection information to either a public switched telephone network or an IP network via the telecommunications management apparatus.

10. The telecommunications management device defined in claim 9, further comprising:
a switch for controlling connection between the plurality of terminals and the telecommunications management apparatus based on a setting of the processor;
a second interface for exchanging information with the public switched telephone network; and
a third interface for exchanging information with the IP network.

11. The telecommunications management device defined in claim 9, wherein the storage device further stores dial signal information of the plurality of terminals and network connection information associated with the dial signal information and wherein the processor receives dial signal information from one of the plurality of terminals, reads from the storage device the network connection information associated with the dial signal information received, and connects the one of the plurality of terminals based on the read network connection information to either the public switched telephone network or the IP network via the telecommunications management apparatus.

12. The telecommunications management device defined in claim 9, further comprising a second interface for updating information stored on the storage device.

13. The telecommunications management device defined in claim 9, wherein the storage device further stores identification information of the plurality of terminals and line status information associated with the identification information and wherein the processor receives information from one of the plurality of terminals, reads from the storage device the line status information associated with the identification information of the one of the plurality of terminals based on the received information, and connects the one of the plurality of terminals to either the public switched telephone network or the IP network via the telecommunications management apparatus when the read line status information indicates that the line of the one of the plurality of terminals is available.
